(19) United States
(12) Patent Application Publication
(10) Pub. No.: US 2014/0059134 A1
(43) Pub. Date: Feb. 27, 2014

(54) MULTIMEDIA DELIVERY SYSTEM AND RELATED COMPUTER PROGRAM PRODUCT FOR PROVIDING STATISTICAL GRAPH RELATED TO AUXILIARY MULTIMEDIA DATA

(71) Applicant: Realtek Semiconductor Corp., Hsinchu (TW)

(72) Inventors: Sun Chien CHIU, Hsinchu (TW); Siu-Leong YU, Hsinchu County (TW); Shih-Chun WEI, Hsinchu City (TW); Chen MA, San Jose, CA (US)

(73) Assignee: Realtek Semiconductor Corp., Hsinchu (TW)

(21) Appl. No.: 13/974,812

(22) Filed: Aug. 23, 2013

Related U.S. Application Data
(60) Provisional application No. 61/813,655, filed on Apr. 19, 2013.
(60) Provisional application No. 61/824,380, filed on May 17, 2013.

(30) Foreign Application Priority Data
Aug. 24, 2012 (TW) 101130868
Aug. 28, 2012 (TW) 101131261
Jul. 26, 2013 (TW) 102126807

(51) Int. Cl. H04L 29/08

(52) U.S. Cl. CPC H04L 67/10
USPC 709/204

(57) ABSTRACT

A multimedia delivery system includes a target data provider device for transmitting a target multimedia data; an auxiliary data provider device for transmitting an auxiliary multimedia data related to the target multimedia data, and for generating a related data distribution information; a first multimedia playback device for receiving the target multimedia data and the data distribution information, generating a statistical graph according to the data distribution information, playing the target multimedia data, and synchronously displaying at least a portion of the statistical graph; and a second multimedia playback device for receiving the auxiliary multimedia data and synchronously displaying related auxiliary multimedia data while the first multimedia playback device plays the target multimedia data.

### CROSS-REFERENCE TO RELATED APPLICATIONS

This application claims the benefit of priority to Patent Application No. 101130868, filed in Taiwan on Aug. 24, 2012; the entirety of which is incorporated herein by reference for all purposes.

This application claims the benefit of priority to Patent Application No. 101131261, filed in Taiwan on Aug. 28, 2012; the entirety of which is incorporated herein by reference for all purposes.

This application claims the benefit of priority to U.S. Provisional Application Ser. No. 61/813,655, filed on Apr. 19, 2013; the entirety of which is incorporated herein by reference for all purposes.

This application claims the benefit of priority to U.S. Provisional Application Ser. No. 61/824,380, filed on May 17, 2013; the entirety of which is incorporated herein by reference for all purposes.

This application claims the benefit of priority to Patent Application No. 102126807, filed in Taiwan on Jul. 26, 2013; the entirety of which is incorporated herein by reference for all purposes.

### BACKGROUND

The disclosure generally relates to a multimedia delivery system provided with multiple display devices and, more particularly, to a multimedia delivery system for providing statistical graphs related to auxiliary multimedia data and related computer program products.

Watching videos through a display device is one of the most popular multimedia applications carried out almost every day by many people. In existing multimedia display technologies, when a user moves a cursor on a screen to a different time point of a progress bar of a multimedia playback program that is currently executed by the display device, the display device displays a video thumbnail image corresponding to the different time point, so that the user is allowed to decide whether to instruct the display device to directly jump the video being currently played to a specific time point in which the user is interested according to the video thumbnail image. In other words, the aforementioned video thumbnail image displayed by the display device is a reference data for the user in deciding whether to switch the video playback time point.

However, in existing technologies, the reference data that the display device could deliver to the user in deciding whether to switch the video playback time point is only limited to the video thumbnail image being currently played. As for a multimedia system adopting the multiple display devices, if the display device is unable to provide more types of reference data for the user in deciding whether to switch the video playback time point, it is difficult for the user to experience the advantages of displaying the multimedia by simultaneously adopting the multiple display devices.

### SUMMARY

An example embodiment of a multimedia delivery system is disclosed, comprising: a target data provider device, configured to operably store and transmit a target multimedia data; an auxiliary data provider device, configured to operably store and transmit multiple auxiliary multimedia data related to the target multimedia data, and to operably generate and transmit a data distribution information, wherein the data distribution information is related to a distribution of the multiple auxiliary multimedia data on a time axis, or a distribution of multiple statistical data respectively corresponding to the multiple auxiliary multimedia data on the time axis; a first multimedia playback device, configured to operably receive the target multimedia data transmitted from the target data provider device, to operably receive the data distribution information transmitted from the auxiliary data provider device, to operably generate a statistical graph according to the data distribution information, to operably play the target multimedia data, and to synchronously display at least a portion of the statistical graph during playback of the target multimedia data; and a second multimedia playback device, configured to operably receive the multiple auxiliary multimedia data transmitted from the auxiliary data provider device, and to synchronously display at least one of the multiple auxiliary multimedia data while the first multimedia playback device plays the target multimedia data; wherein the statistical graph is utilized for expressing the distribution of the multiple auxiliary multimedia data on the time axis, or for expressing the distribution of the multiple statistical data on the time axis.

Another example embodiment of a multimedia delivery system is disclosed, comprising: a target data provider device, configured to operably store and transmit a first target multimedia data and a second target multimedia data; an auxiliary data provider device, configured to operably store and transmit multiple first auxiliary multimedia data related to the first target multimedia data, to operably store and transmit multiple second auxiliary multimedia data related to the second target multimedia data, to operably generate and transmit a first data distribution information, and to operably generate and transmit a second data distribution information, wherein the first data distribution information is related to a distribution of the multiple first auxiliary multimedia data on a time axis or related to a distribution of multiple first statistical data respectively corresponding to the multiple first auxiliary multimedia data on the time axis, and the second data distribution information is related to a distribution of the multiple second auxiliary multimedia data on the time axis or related to a distribution of multiple second statistical data respectively corresponding to the multiple second auxiliary multimedia data on the time axis; a first multimedia playback device, configured to operably receive the first target multimedia data and the second target multimedia data transmitted from the target data provider device, to operably receive the first data distribution information and the second data distribution information transmitted from the auxiliary data provider device, to operably generate a first statistical graph according to the first data distribution information, to operably generate a second statistical graph according to the second data distribution information, and to synchronously display a first representative image of the first target multimedia data, a second representative image of the second target multimedia data, at least a portion of the first statistical graph, and at least a portion of the second statistical graph; and a second multimedia playback device, configured to operably receive the multiple first auxiliary multimedia data and the multiple second auxiliary multimedia data transmitted from the auxiliary data provider device; wherein the first statistical graph is utilized for expressing the distribution of the multiple first auxiliary multimedia data on the time axis or for expressing the distribution of the multiple first statistical data on the time axis, and the second statistical graph is utilized for expressing the distribution of the multiple second auxiliary multimedia data on the time axis or for expressing the distribution of the multiple second statistical data on the time axis; wherein after the first representative image is selected by a user, the first multimedia playback device starts to play the first target multimedia data, and synchronously displays at least a portion of the first statistical graph during playback of the first target multimedia data, and the second multimedia playback device synchronously plays at least one of the multiple first auxiliary multimedia data while the first multimedia playback device plays the first target multimedia data.

An example embodiment of a computer program product is disclosed. The computer program product is stored in a non-transitory storage device of a first multimedia playback device in a multimedia delivery system. The multimedia delivery system comprises a target data provider device, an auxiliary data provider device, the first multimedia playback device, and a second multimedia playback device. The first multimedia playback device comprises a communication circuit, a display device, a speaker, and a control circuit. When the computer program product is executed by the control circuit of the first multimedia playback device, the computer program product enables the first multimedia playback device to perform a multimedia playback operation. The computer program product comprises: a receiving module, for utilizing the communication circuit to receive a target multimedia data transmitted from the target data provider device, and to receive a data distribution information transmitted from the auxiliary data provider device, wherein the data distribution information is related to a distribution of multiple auxiliary multimedia data related to the target multimedia data on a time axis or related to a distribution of multiple statistical data respectively corresponding to the multiple auxiliary multimedia data on the time axis; a statistical graph generating module, for utilizing the control circuit to generate a statistical graph according to the data distribution information, wherein the statistical graph is utilized for expressing the distribution of the multiple auxiliary multimedia data on the time axis or for expressing the distribution of the multiple statistical data on the time axis; and a playback module, for utilizing at least one of the display device and the speaker to play the target multimedia data, and for utilizing the display device to synchronously display at least a portion of the statistical graph during playback of the target multimedia data.

Both the foregoing general description and the following detailed description are examples and explanatory only, and are not restrictive of the invention as claimed.

### BRIEF DESCRIPTION OF THE DRAWINGS

FIG. 1 shows a simplified functional block diagram of a multimedia delivery system according to one embodiment of the present disclosure.

FIG. 2 shows a simplified schematic diagram of functional modules of a computer program product in a first multimedia playback device of FIG. 1 according to one embodiment of the present disclosure.

FIG. 3 shows a simplified flowchart of a multimedia playback method according to one embodiment of the present disclosure.

FIG. 4 shows a simplified schematic diagram of a data distribution information according to one embodiment of the present disclosure.

FIG. 5 shows a simplified enlarged schematic diagram of a statistical graph according to one embodiment of the present disclosure.

FIG. 6 shows a simplified schematic diagram of playing a target multimedia data conducted by the first multimedia playback device of FIG. 1 according to one embodiment of the present disclosure.

FIG. 7 and FIG. 8 show simplified schematic diagrams of synchronously playing an auxiliary multimedia data conducted by a second multimedia playback device of FIG. 1 according to different embodiments of the present disclosure.

FIG. 9 shows a simplified enlarged schematic diagram of a statistical graph according to another embodiment of the present disclosure.

FIG. 10 shows a simplified schematic diagram of playing the target multimedia data conducted by the first multimedia playback device of FIG. 1 according to another embodiment of the present disclosure.

FIG. 11 and FIG. 12 show simplified schematic diagrams of playing the target multimedia data in a full screen mode conducted by the first multimedia playback device of FIG. 1 according to different embodiments of the present disclosure.

FIG. 13 shows a simplified schematic diagram of playing the target multimedia data conducted by the first multimedia playback device of FIG. 1 according to another embodiment of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

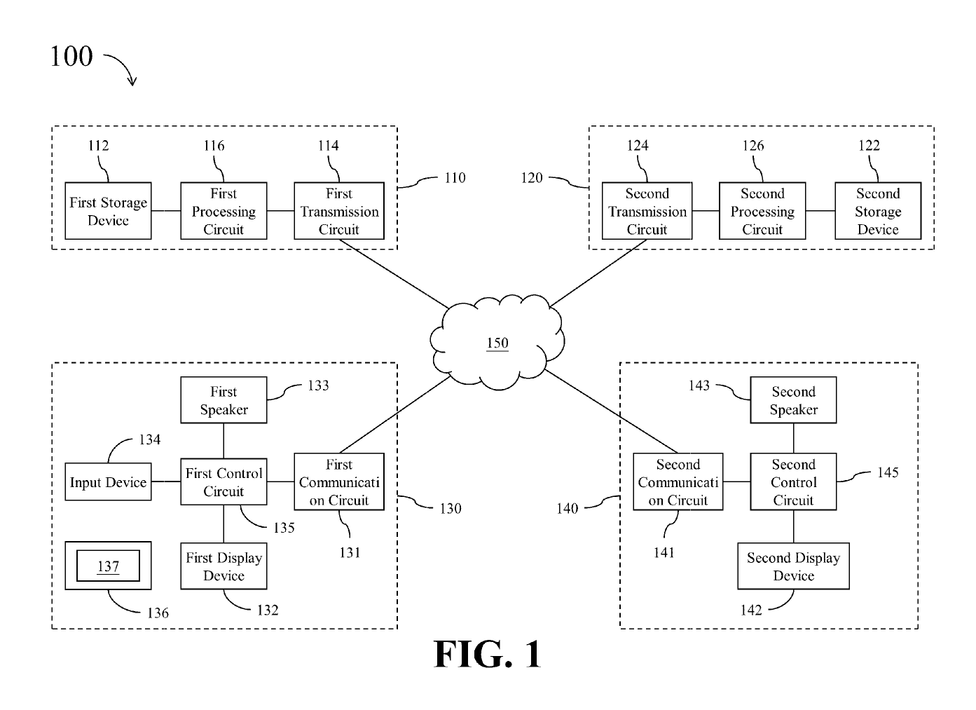

FIG. 1 shows a simplified functional block diagram of a multimedia delivery system 100 according to one embodiment of the present disclosure. The multimedia delivery system 100 comprises a target data provider device 110, an auxiliary data provider device 120, a first multimedia playback device 130, and a second multimedia playback device 140.

The target data provider device 110 is configured to operably store a target multimedia data and to operably transmit the target multimedia data to the first multimedia playback device 130 through a network 150 by adopting wired and/or wireless communications. The aforementioned target multimedia data may be various kinds or images and/or audio contents.

The auxiliary data provider device 120 is configured to operably store multiple auxiliary multimedia data related to the target multimedia data and to operably collect and store multiple statistical data respectively corresponding to the multiple auxiliary multimedia data. Additionally, the auxiliary data provider device 120 is further configured to operably generate and transmit a data distribution information. The auxiliary data provider device 120 may transmit the multiple auxiliary multimedia data to the second multimedia playback device 140 through the network 150, and may transmit the data distribution information to the first multimedia playback device 130 through the network 150 by adopting wired and/or wireless communications.

The first multimedia playback device 130 is configured to operably receive the target multimedia data transmitted from the target data provider device 110, to operably receive the data distribution information transmitted from the auxiliary data provider device 120, and to operably generate a statistical graph according to the data distribution information. The first multimedia playback device 130 is further configured to operably play the target multimedia data and to synchronously display at least a portion of the statistical graph during playback of the target multimedia data.

The second multimedia playback device 140 is configured to operably receive the multiple auxiliary multimedia data transmitted from the auxiliary data provider device 120, and to synchronously display at least one of the multiple auxiliary multimedia data while the first multimedia playback device 130 plays the target multimedia data.

The aforementioned network 150 may be the internet or an intranet adopting various kinds of communication protocols.

The multiple auxiliary multimedia data stored in the auxiliary data provider device 120 are additional text, picture, image, and/or audio data prepared in advance for the target multimedia data stored in the target data provider device 110. For example, each auxiliary multimedia data may be additional data prepared in advance for one or more items (hereinafter referred to as objects), such as characters, articles, sounds, scenes, stories, locations, or time appearing in a certain period of the target multimedia data. These auxiliary multimedia data may have multiple purposes. For example, the auxiliary multimedia data may be advertisements, supplementary information, detailed introduction, relevant instructions, or user comments related to the target multimedia data provided by the target data provider device 110. The aforementioned auxiliary multimedia data may be prepared by the operators of the target data provider device 110 or the auxiliary data provider device 120. Alternatively, the aforementioned auxiliary multimedia data may be produced and uploaded to the auxiliary data provider device 120 by audiences of the target multimedia data.

When the first multimedia playback device 130 plays the target multimedia data transmitted from the target data provider device 110, the second multimedia playback device 140 synchronously displays the multiple auxiliary multimedia data related to multiple objects in the target multimedia data, so as to provide additional information related to the target multimedia data for the users.

In practice, the aforementioned multiple statistical data may be multiple ranking scores respectively corresponding to the multiple auxiliary multimedia data. For example, each statistical data may be a total ranking score or an average ranking score of the same auxiliary multimedia data made by different users. For example, the auxiliary data provider device 120 may collect a total number of endorsements, likes, or positive feedbacks of a specific auxiliary multimedia data from different users, and may utilize the collected number as the statistical data of the specific auxiliary multimedia data.

Alternatively, the aforementioned multiple statistical data may be multiple annotation counts respectively corresponding to the multiple auxiliary multimedia data. For example, each statistical data may be a total quantity of annotations (hereafter, an annotation count) for the same auxiliary multimedia data provided by the same user or by different users. The aforementioned annotations may be presented in the format of plain texts or various kinds of multimedia. For example, the user may produce a multimedia file about his experiences, feelings, or supplementary information for the specific auxiliary multimedia data, and may upload the multimedia file to the auxiliary data provider device 120 to be an annotation for the specific auxiliary multimedia data.

In one embodiment, the auxiliary data provider device 120 generates information for describing a distribution of the multiple auxiliary multimedia data on a time axis as the data distribution information. In this situation, the statistical graph generated by the first multimedia playback device 130 is utilized for expressing the distribution of the multiple auxiliary multimedia data on the time axis.

In another embodiment, the auxiliary data provider device 120 generates information for describing a distribution of the multiple statistical data on a time axis as the data distribution information. In this situation, the statistical graph generated by the first multimedia playback device 130 is utilized for expressing the distribution of the multiple statistical data on the time axis.

As can be appreciated from the foregoing descriptions, the data distribution information generated by the auxiliary data provider device 120 may be related to the distribution of the multiple auxiliary multimedia data on the time axis, or related to the distribution of the multiple statistical data on the time axis.

In the embodiment of FIG. 1, the target data provider device 110 comprises a first storage device 112, a first transmission circuit 114, and a first processing circuit 116. The auxiliary data provider device 120 comprises a second storage device 122, a second transmission circuit 124, and a second processing circuit 126. The first multimedia playback device 130 comprises a first communication circuit 131, a first display device 132, a first speaker 133, an input device 134, a first control circuit 135, and a memory 136, wherein the memory 136 is stored with a computer program product 137. The second multimedia playback device 140 comprises a second communication circuit 141, a second display device 142, a second speaker 143, and a second control circuit 145.

In the target data provider device 110, the first storage device 112 is configured to operably store the aforementioned target multimedia data. The first processing circuit 116 is coupled with the first storage device 112 and the first transmission circuit 114, and configured to operably control the first transmission circuit 114 to transmit the target multimedia data.

In the auxiliary data provider device 120, the second storage device 122 is configured to operably store the multiple auxiliary multimedia data and the data distribution information. The second processing circuit 126 is coupled with the second storage device 122 and the second transmission circuit 124, and configured to operably generate the data distribution information, and to operably control the second transmission circuit 124 to transmit the multiple auxiliary multimedia data and the data distribution information.

Each of the first transmission circuit 114 and the second transmission circuit 124 may be realized with a wired networking circuit, a wireless networking circuit or a hybrid circuit integrated with the functionalities of the above two circuits. Each of the first processing circuit 116 and the second processing circuit 126 may be realized with one or more processor units.

The operator of the target data provider device 110 may be a cable television company, a wireless television company, an audio and video media supplier, or an audio and video media website, and the operator of the auxiliary data provider device 120 may be a cable television company, a wireless television company, an advertisement distributor, an audio and video media website, or other information providing website. In practice, each of the target data provider device 110 and the auxiliary data provider device 120 may be realized with a single server, or may be realized with a combination of multiple servers located in the same geographical area or located in different geographical areas. In some embodiments, the functionalities of the target data provider device 110 and the auxiliary data provider device 120 may be integrated together and under control of the same operator.

In the first multimedia playback device 130, the first communication circuit 131 is configured to operably receive the target multimedia data transmitted from the target data provider device 110, and to operably receive the data distribution information transmitted from the auxiliary data provider device 120. The first control circuit 135 is coupled with the first communication circuit 131, the first display device 132, the first speaker 133, the input device 134, and the memory 136. The first control circuit 135 is configured to operably generate the statistical graph according to the data distribution information, to operably control at least one of the first display device 132 and the first speaker 133 to play the target multimedia data, and to operably control the first display device 132 to synchronously display at least a portion of the statistical graph during the playback of the target multimedia data.

In the second multimedia playback device 140, the second communication circuit 141 is configured to operably receive the multiple auxiliary multimedia data transmitted from the auxiliary data provider device 120. The second control circuit 145 is coupled with the second communication circuit 141, the second display device 142, and the second speaker 143. The second control circuit 145 is configured to operably control at least one of the second display device 142 and the second speaker 143 to synchronously play at least one of the multiple auxiliary multimedia data while the first multimedia playback device 130 plays the target multimedia data.

Each of the first communication circuit 131 and the second communication circuit 141 may be realized with a wired networking circuit, a wireless networking circuit, or a hybrid circuit integrated with the functionalities of the above two circuits. Each of the first control circuit 135 and the second control circuit 145 may be realized with one or more processor units.

The first multimedia playback device 130 may be realized with any device capable of connecting to the network and playing the target multimedia data, such as a computer (e.g., a tablet computer, a notebook computer, or a netbook computer), a TV, or a home theater system. The second multimedia playback device 140 may be realized with any portable electronic device having a screen and capable of connecting to the network, such as a mobile phone, a tablet computer, a notebook computer, a netbook computer, an electronic book, or a handheld game console.

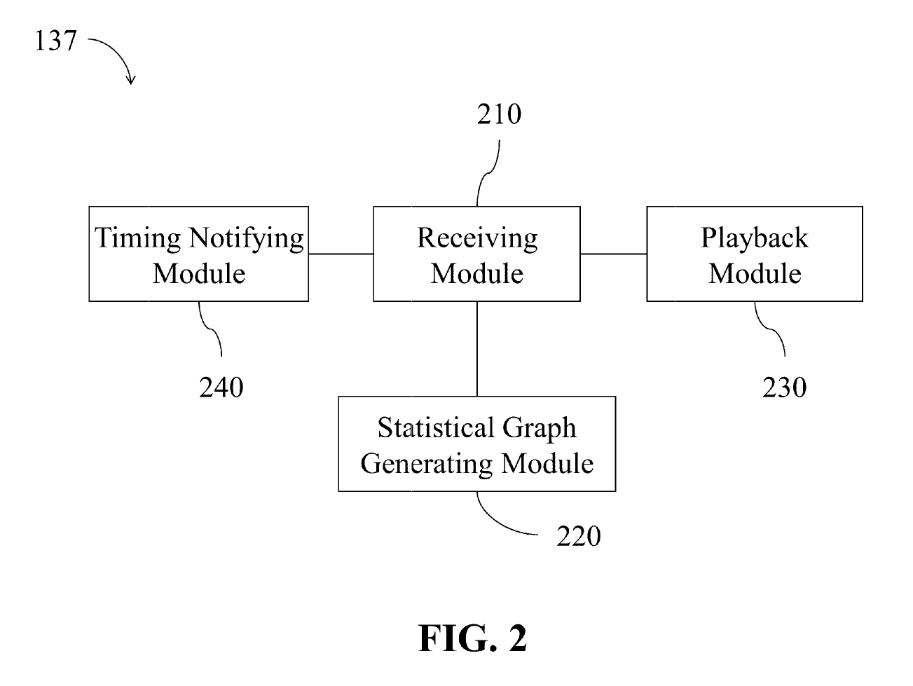

The computer program product 137 in the aforementioned first multimedia playback device 130 may be realized with one or more application program modules. For example, FIG. 2 shows a simplified schematic diagram of functional modules of the computer program product 137 in FIG. 1 according to one embodiment of the present disclosure. In this embodiment, the computer program product 137 comprises a receiving module 210, a statistical graph generating module 220, a playback module 230, and a timing notifying module 240.

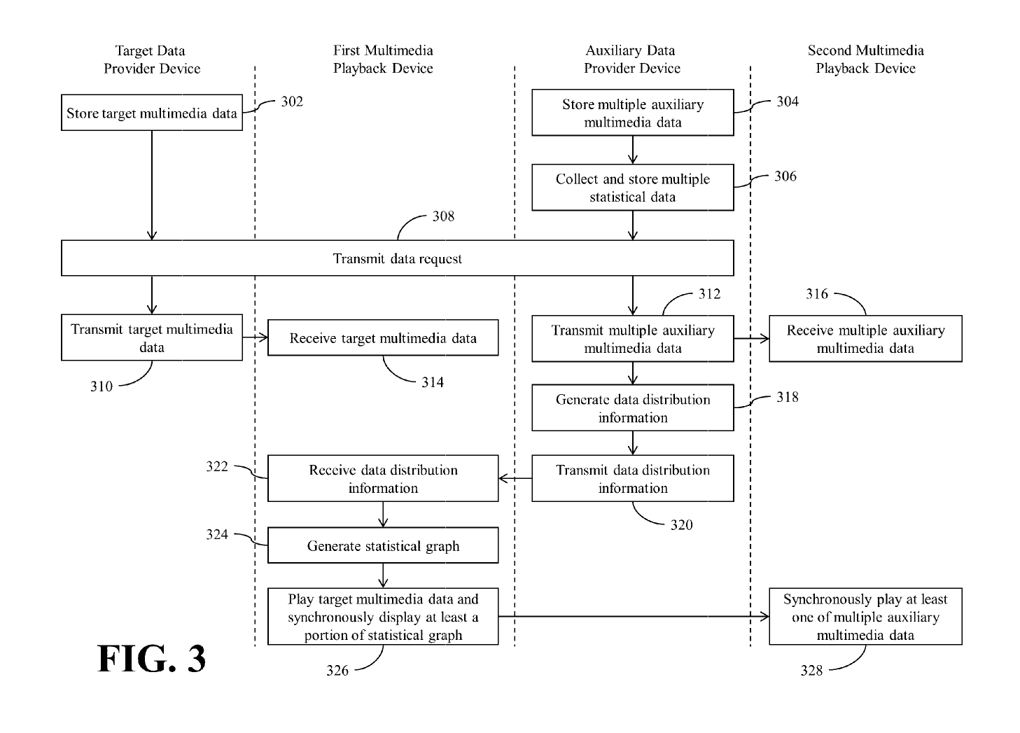

The operations of the multimedia delivery system 100 will be further described in the following by reference to FIG. 3 through FIG. 7.

FIG. 3 shows a simplified flowchart illustrating a multimedia playback method according to one embodiment of the present disclosure. In the flowchart of FIG. 3, operations within a column under the name of a specific device are operations to be performed by the specific device. For example, operations within a column under the label “target data provider device” are operations to be performed by the target data provider device 110; operations within a column under the label “auxiliary data provider device” are operations to be performed by the auxiliary data provider device 120; operations within a column under the label “first multimedia playback device” are operations to be performed by the first multimedia playback device 130; and operations within a column under the label “second multimedia playback device” are operations to be performed by the second multimedia playback device 140.

When performing the multimedia playback method of FIG. 3, the first control circuit 135 of the first multimedia playback device 130 executes the computer program product 137 in the memory 136 to enable the first multimedia playback device 130 to perform a multimedia playback operation comprising some or all operations within the corresponding column.

In the operation 302, the first processing circuit 116 of the target data provider device 110 stores the aforementioned target multimedia data to the first storage device 112. In practice, the first storage device 112 may store many target multimedia data that can be downloaded by the first multimedia playback device 130.

In the operation 304, the second processing circuit 126 of the auxiliary data provider device 120 stores the aforementioned multiple auxiliary multimedia data to the second storage device 122.

In the operation 306, the second processing circuit 126 collects multiple statistical data respectively corresponding to the multiple auxiliary multimedia data, and stores the multiple statistical data to the second storage device 122. As previously described, the second processing circuit 126 may collect a total number of endorsements, likes, or positive feedbacks of a specific auxiliary multimedia data from different users, and may utilize the collected number as the statistical data of the specific auxiliary multimedia data.

When the user of the first multimedia playback device 130 utilizes the first multimedia playback device 130 to playback a target multimedia data, the first control circuit 135 of the first multimedia playback device 130 performs the operation 308 to generate a data request corresponding to the target multimedia data and to transmit the data request to the target data provider device 110 and the auxiliary data provider device 120. In one embodiment, the first control circuit 135 may control the first communication circuit 131 to simultaneously transmit the data request the target data provider device 110 and the auxiliary data provider device 120 through the network 150. In another embodiment, the first control circuit 135 may control the first communication circuit 131 to transmit the data request to the target data provider device 110 through the network 150, and then the target data provider device 110 forwards the data request to the auxiliary data provider device 120. In another embodiment, the first control circuit 135 may control the first communication circuit 131 to transmit the data request to the auxiliary data provider device 120 through the network 150, and then the auxiliary data provider device 120 forwards the data request to the target data provider device 110.

Then, the target data provider device 110 performs the operation 310, and the auxiliary data provider device 120 performs the operation 312.

In the operation 310, the first processing circuit 116 controls the first transmission circuit 114 to transmit the target multimedia data stored in the first storage device 112 to the first multimedia playback device 130 through the network 150 according to the data request.

In the operation 312, the second processing circuit 126 controls the second transmission circuit 124 to transmit the multiple auxiliary multimedia data, stored in the second storage device 122 and corresponding to the target multimedia data, to the second multimedia playback device 140 through the network 150 according to the data request.

In the operation 314, the receiving module 210 of the computer program product 137 utilizes the first communication circuit 131 to receive the target multimedia data transmitted from the first transmission circuit 114.

In the operation 316, the second communication circuit 141 receives the multiple auxiliary multimedia data transmitted from the second transmission circuit 124.

In the operation 318, the second processing circuit 126 generates a data distribution information related to the multiple auxiliary multimedia data. As previously described, the second processing circuit 126 may generate the information for describing the distribution of the multiple auxiliary multimedia data in multiple different periods of a time axis as the data distribution information. Alternatively, the second processing circuit 126 may generate the information for describing the distribution of the multiple statistical data in multiple different periods of the time axis as the data distribution information. Each of the aforementioned multiple different periods has a predetermined length of time the same as each other.

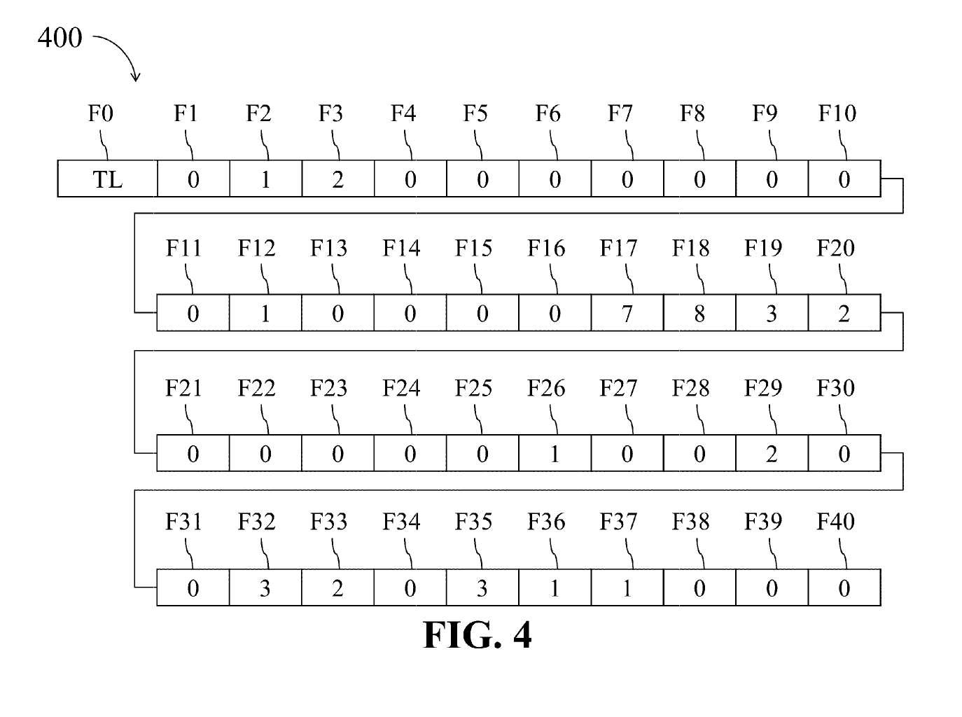

FIG. 4 shows a simplified schematic diagram of a data distribution information 400 according to one embodiment of the present disclosure. The data distribution information 400 comprises a time length field F0 and multiple information fields. For example, in the embodiment of FIG. 4, the data distribution information 400 comprises forty information fields F1˜F40. The time length column F0 is utilized for recording a predetermined length of time TL. The information fields F1˜F40 are respectively utilized for recording the distribution of the multiple auxiliary multimedia data in forty different periods P1˜P40 of a time axis, or for recording the distribution of the multiple statistical data in forty different periods P1˜P40 of the time axis. The aforementioned periods P1˜P40 are successive periods, and each of the periods has the predetermined length of time TL the same as each other.

In one embodiment, the information field F1 may be utilized for recording a quantity of auxiliary multimedia data that appear in the first period P1, the information field F2 may be utilized for recording a quantity of auxiliary multimedia data that appear in the second period P2, the information field F3 may be utilized for recording a quantity of auxiliary multimedia data that appear in the third period P3, and so forth. In this situation, the information field F40 may be utilized for recording a quantity of auxiliary multimedia data that appear in the fortieth period P40.

In another embodiment, the information field F1 may be utilized for recording a quantity of statistical data that appear in the first period P1, the information field F2 may be utilized for recording a quantity of statistical data that appear in the second period P2, the information field F3 may be utilized for recording a quantity of statistical data that appear in the third period P3, and so forth. In this situation, the information field F40 may be utilized for recording a quantity of statistical data that appear in the fortieth period P40.

In the operation 320, the second processing circuit 126 controls the second transmission circuit 124 to transmit the data distribution information to the first multimedia playback device 130 through the network 150.

In the operation 322, the receiving module 210 of the computer program product 137 utilizes the first communication circuit 131 to receive the data distribution information transmitted from the second transmission circuit 124.

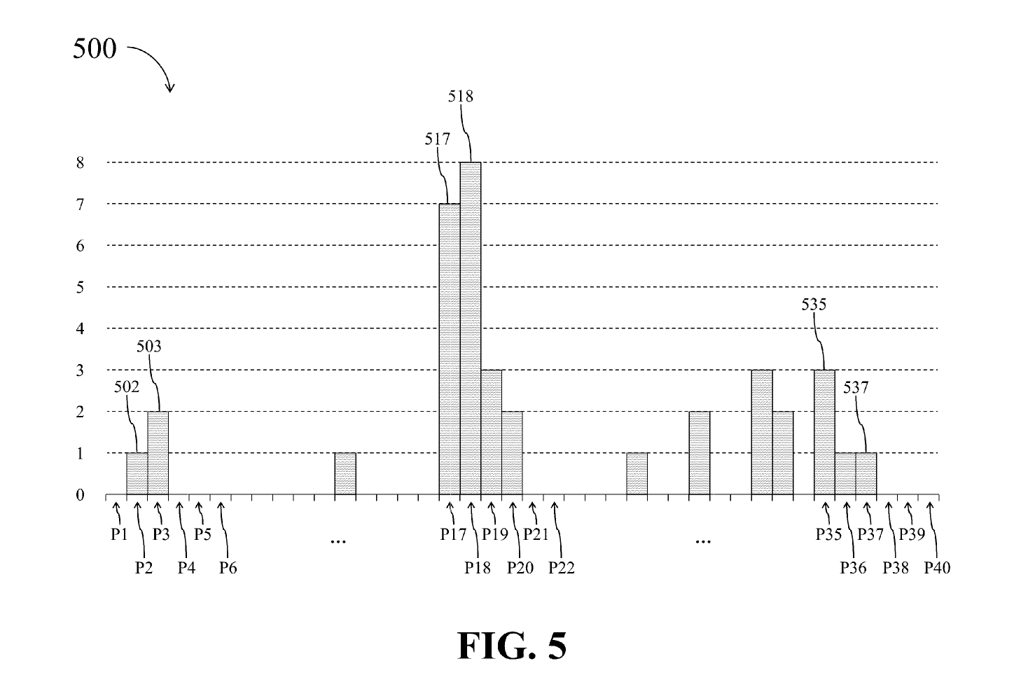

In the operation 324, the statistical graph generating module 220 of the computer program product 137 utilizes the first control circuit 135 to generate a statistical graph according to the data distribution information. In practice, the statistical graph generated by the first control circuit 135 may be a histogram or a line chart. For example, FIG. 5 shows a simplified enlarged schematic diagram of a statistical graph 500 according to one embodiment of the present disclosure. In FIG. 5, the statistical graph 500 is presented in the format of a histogram, and numbers located at the left side of the statistical graph 500 are utilized for expressing a quantity distribution of specific items with respect to each period.

In the embodiment where the aforementioned data distribution information is utilized for describing the distribution of the multiple auxiliary multimedia data on the time axis, the first control circuit 135 converts the distribution of the multiple auxiliary multimedia data in the periods P1˜P40 into multiple indicator objects on the statistical graph 500, so that the multiple indicator objects respectively correspond to the periods P1˜P40. In this situation, each indicator object of the multiple indicator objects represents a total quantity of auxiliary multimedia data corresponding to one of the periods P1˜P40. Accordingly, the statistical graph 500 generated by the first control circuit 135 may be utilized for expressing the distribution of the multiple auxiliary multimedia data on the time axis. For example, in this case an indicator object 502 on the statistical graph 500 represents the total quantity of auxiliary multimedia data appearing in the period P2, an indicator object 503 represents the total quantity of auxiliary multimedia data appearing in the period P3, an indicator object 517 represents the total quantity of auxiliary multimedia data appearing in the period P17, an indicator object 518 represents the total quantity of auxiliary multimedia data appearing in the period P18, an indicator object 535 represents the total quantity of auxiliary multimedia data appearing in the period P35, an indicator object 537 represents the total quantity of auxiliary multimedia data appearing in the period P37, and so forth.

In the embodiment where the aforementioned data distribution information is utilized for describing the distribution of the multiple statistical data on the time axis, the first control circuit 135 converts the distribution of the multiple statistical data in the periods P1˜P40 into the multiple indicator objects on the statistical graph 500, so that the multiple indicator objects respectively correspond to the periods P1˜P40. In this situation, each indicator object of the multiple indicator objects represents a sum or weighted-blending result of statistical data corresponding to one of the periods P1˜P40. Accordingly, the statistical graph 500 generated by the first control circuit 135 may be utilized for expressing the distribution of the multiple statistical data on the time axis. For example, in this case the indicator object 502 on the statistical graph 500 represents the sum or weighted-blending result of statistical data corresponding to the period P2, the indicator object 503 represents the sum or weighted-blending result of statistical data corresponding to the period P3, the indicator object 517 represents the sum or weighted-blending result of statistical data corresponding to the period P17, the indicator object 518 represents the sum or weighted-blending result of statistical data corresponding to the period P18, the indicator object 535 represents the sum or weighted-blending result of statistical data corresponding to the period P35, the indicator object 537 represents the sum or weighted-blending result of statistical data corresponding to the period P37, and so forth.

In the operation 326, the first control circuit 135 controls at least one of the first display device 132 and the first speaker 133 to play the target multimedia data. During the playback of the target multimedia data, the playback module 230 of the computer program product 137 utilizes the first display device 132 to synchronously display at least a portion of the statistical graph 500.

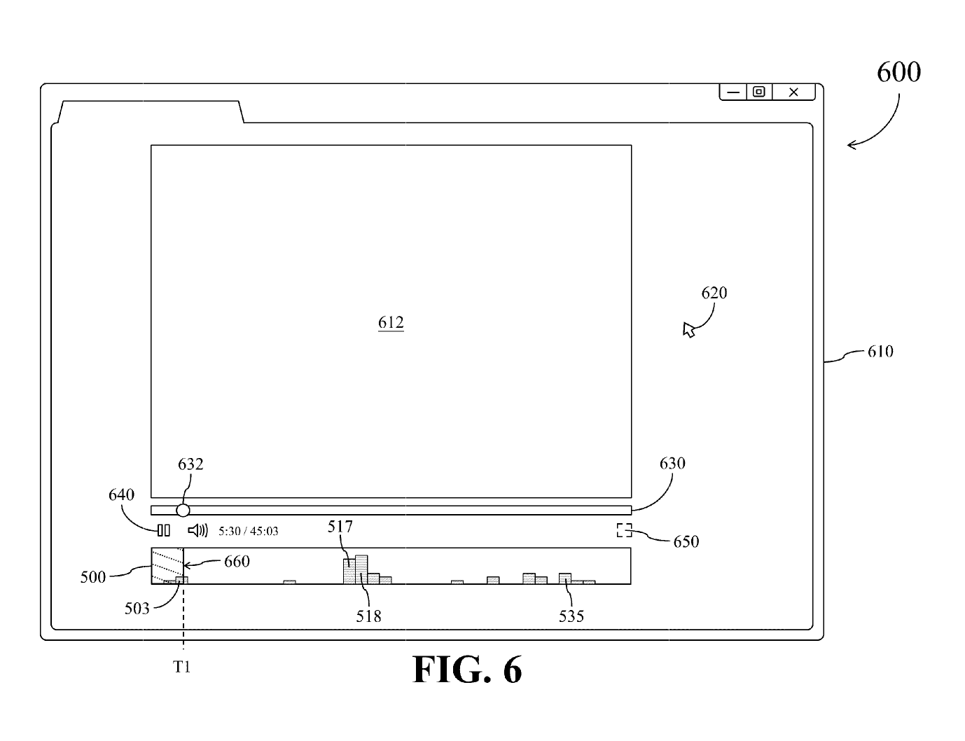

For example, FIG. 6 shows a simplified schematic diagram of playing a target multimedia data conducted by the first multimedia playback device 130 according to one embodiment of the present disclosure. As shown in FIG. 6, the first control circuit 135 controls the first display device 132 to display an image 600. The image 600 comprises a display region 610 and a cursor 620. The display region 610 may be a window region of an application program (such as a web browser or a multimedia player). In this embodiment, the first display device 132 displays the images of the target multimedia data in a partial region 612 of the display region 610, and displays a progress bar 630, a pause key 640, and a full-screen-mode key 650 in the display region 610. The progress bar 630 comprises a progress indicator 632 utilized for indicating a current playback time of the target multimedia data.

During the playback of the target multimedia data, the playback module 230 utilizes the first display device 132 to synchronously display the aforementioned statistical graph 500 in the display region 610. For example, as shown in FIG. 6, the playback module 230 may utilize the first display device 132 to synchronously display the aforementioned statistical graph 500 under the display region of the target multimedia data (i.e., the aforementioned partial region 612 in this case). In practice, the statistical graph 500 displayed by the first display device 132 may have a length equal to the length of the progress bar 630, or may be scaled as needed.

Additionally, the playback module 230 may further control the first display device 132 to display a time indicator 660 corresponding to the current playback time of the target multimedia data on the statistical graph 500, so as to align the position of the time indicator 660 with the progress indicator 632 in the progress bar 630. The playback module 230 further utilizes the first display device 132 to synchronously move the position of the time indicator 660 during the playback of the target multimedia data, so that the time indicator 660 on the statistical graph 500 has a functionality for indicating the playback progress similar to the functionality of the progress indicator 632.

During the playback of the target multimedia data, the second control circuit 145 of the second multimedia playback device 140 performs the operation 328 to control at least one of the second display device 142 and the second speaker 143 to synchronously play at least one of the multiple auxiliary multimedia data, so that the auxiliary multimedia data being currently played by the second multimedia playback device 140 can be corresponding to the current content of the target multimedia data being played in the first multimedia playback device 130.

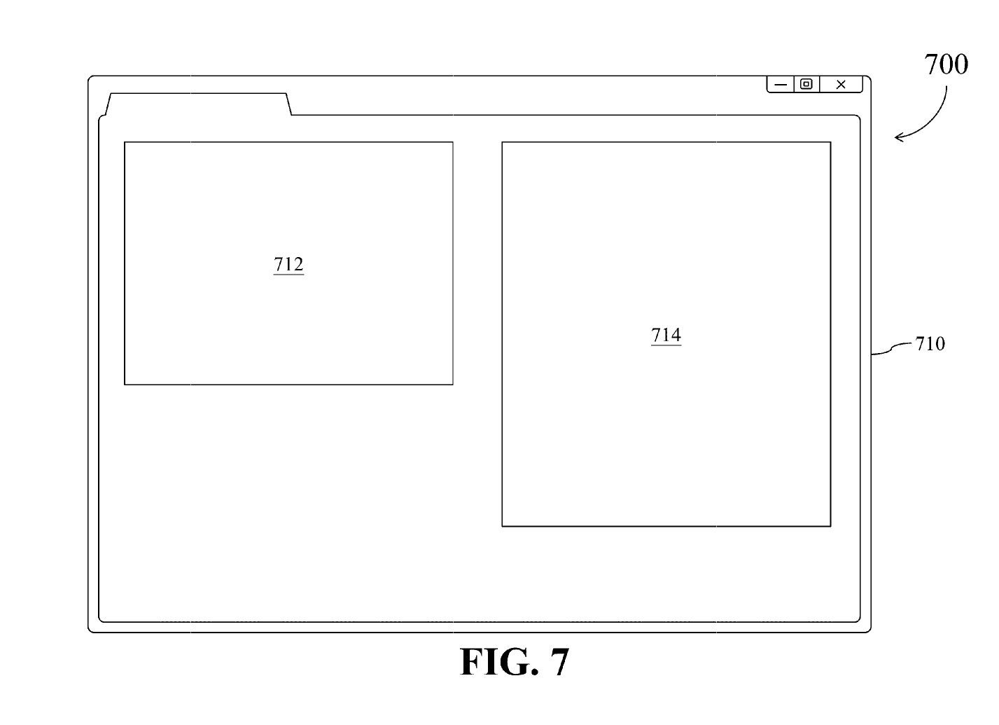

Taking the case of FIG. 6 as an example, when the progress indicator 632 in the progress bar 630 moves to a position corresponding to a time point T1, the time indicator 660 on the statistical graph 500 moves to a position of the indicator object 503. As can be appreciated from FIG. 5 and the foregoing descriptions, the number represented by the indicator object 503 is a value, two. In the embodiment where the statistical graph 500 is utilized for expressing the distribution of the multiple auxiliary multimedia data on the time axis, the indicator object 503 represents that there are two auxiliary multimedia data appearing in the period P3. In this situation, the second control circuit 145 controls the second display device 142 to display an image 700, as shown in FIG. 7. The image 700 comprises a display region 710. The display region 710 may be a window region of the application program (such as a web browser or a multimedia player). The second display device 142 synchronously displays two auxiliary multimedia data, which correspond to the current content of the target multimedia data being played by the first multimedia playback device 130, in the display region 710. For the illustrative purpose, it is herein assumed that the two auxiliary multimedia data corresponding to the current content of the target multimedia data are a first auxiliary multimedia data and a second auxiliary multimedia data. The second display device 142 may display the content of the first auxiliary multimedia data in a first sub-region 712 within the display region 710, and may display the content of the second auxiliary multimedia data in a second sub-region 714 within the display region 710. The second control circuit 145 may configure respective size and position for the sub-regions 712 and 714 according to data amounts, appearance order, priority, or producer identities of the first auxiliary multimedia data and the second auxiliary multimedia data, areas of the display region 710, or other various criteria.

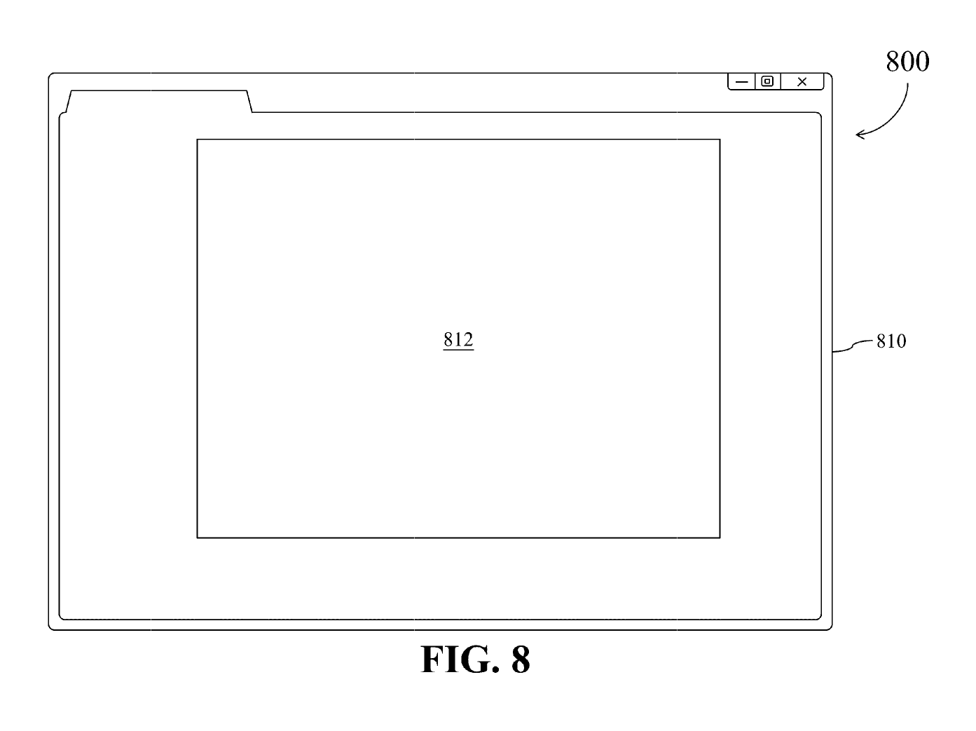

In the embodiment where the statistical graph 500 is utilized for expressing the distribution of the multiple statistical data on the time axis, the indicator object 503 represents that the sum or weighted-blending result of statistical data corresponding to the period P3 is a value, two. As previously described, each statistical data may be the total ranking score or the average ranking score of the same auxiliary multimedia data made by different users. Alternatively, each statistical data may be the annotation counts for the same auxiliary multimedia data provided by the same user or by the different users. In this situation, the second control circuit 145 controls the second display device 142 to display an image 800, as shown in FIG. 8. The image 800 comprises a display region 810. The display region 810 may be a window region of the application program (such as a web browser or a multimedia player). The second display device 142 synchronously displays one or more auxiliary multimedia data corresponding to the statistical data corresponding to the period P3 in the display region 810. For illustrative purpose, it is herein assumed that the auxiliary multimedia data corresponding to the statistical data corresponding to the period P3 is a third auxiliary multimedia data. The second display device 142 may display the content of the third auxiliary multimedia data in a sub-region 812 within the display region 810. Similarly, the second control circuit 145 may configure a size and a position for the sub-region 812 according to various kinds of criteria.

In the operation 328, the second control circuit 145 controls a playback timing of the multiple auxiliary multimedia data according to appropriate playback timing information.

In one embodiment, the second processing circuit 126 of the auxiliary data provider device 120 may control the second transmission circuit 124 to transmit multiple playback timing information respectively corresponding to the multiple auxiliary multimedia data to the second communication circuit 141 of the second multimedia playback device 140 in the aforementioned operation 312, or before or after the operation 312, so as to enable the second control circuit 145 to control the playback timing of the multiple auxiliary multimedia data in the operation 328 according to the multiple playback timing information.

In another embodiment, the timing notifying module 240 of the computer program product 137 utilizes the first communication circuit 131 to provide the playback timing information of the target multimedia data for the second multimedia playback device 140 in the aforementioned operation 326 or before the operation 326, so as to enable the second control circuit 145 to control the playback timing of the multiple auxiliary multimedia data in the operation 328 according to the playback timing information of the target multimedia data.

While the first multimedia playback device 130 plays the target multimedia data, the user may move the cursor 620 within the image 600 to the pause key 640 and click the pause key 640 to issue a pause command.

In one embodiment, when a pause command issued by the user is received by the receiving module 210 of the computer program product 137 through the input device 134, the timing notifying module 240 utilizes the first communication circuit 131 to transmit a pause notice to the second transmission circuit 124. When the pause notice is received by the second transmission circuit 124, the second processing circuit 126 instructs the second multimedia playback device 140 to pause playing the multiple auxiliary multimedia data through the second transmission circuit 124. When the instruction of the auxiliary data provider device 120 is received by the second control circuit 145, the second control circuit 145 controls the second display device 142 and the second speaker 143 to pause playing the multiple auxiliary multimedia data.

In another embodiment, when the pause command issued by the user is received by the receiving module 210 through the input device 134, the timing notifying module 240 utilizes the first communication circuit 131 to provide a pause notice for the second control circuit 145 of the second multimedia playback device 140 through the second communication circuit 141. When the pause notice is received by the second control circuit 145, the second control circuit 145 controls the second display device 142 and the second speaker 143 to pause playing the multiple auxiliary multimedia data.

As can be appreciated from the foregoing descriptions, the user is able to recognize the playback progress of the target multimedia data from the progress bar 630 and the progress indicator 632 displayed by the first display device 132, but is unable to obtain relevant information of the auxiliary multimedia data being currently played by the second multimedia playback device 140 from the progress bar 630 and the progress indicator 632 displayed by the first display device 132. However, the user is not only allowed to recognize the playback progress of the target multimedia data, but also enabled to obtain the quantity of auxiliary multimedia data to be played at a specific time point by the second multimedia playback device 140 or related statistical data from the statistical graph 500 and the time indicator 660 displayed by the first display device 132.

Accordingly, through the statistical graph 500 and the time indicator 660 displayed by the first multimedia playback device 130, the user is enabled to obtain the most updated playback timing and related information of the multiple auxiliary multimedia data being currently played by the second multimedia playback device 140, and thus would not miss the auxiliary multimedia data being currently played by the second multimedia playback device 140.

Additionally, the statistical graph 500 and the time indicator 660 displayed by the first multimedia playback device 130 could also be employed as a reference data for the user in deciding whether to switch the playback time point of the target multimedia data.

As previously described, each indicator object on the statistical graph 500 may be utilized for representing a total quantity of auxiliary multimedia data corresponding to a specific period. In this situation, the larger value represented by a specific indicator object means that there are more auxiliary multimedia data corresponding to a specific period. To a certain extent, this represents that the content of the target multimedia data is more interesting, receives more attention, or causes more discussion in the specific period.

Alternatively, each indicator object on the statistical graph 500 may be also utilized for representing a sum or weighted-blending result of statistical data corresponding to a specific period. In this situation, the larger value represented by a specific indicator object means the higher score of the sum or weighted-blending result of statistical data corresponding to a specific period. To a certain extent, this represents that the content of the target multimedia data is more interesting, receives more attention, or has higher rating in the specific period.

Accordingly, the user is enabled to decide whether to switch the playback time point of the target multimedia data according to the value represented by respective indicator objects on the statistical graph 500. In other words, the statistical graph 500 displayed by the aforementioned first multimedia playback device 130 could be employed as an important reference data for the user in deciding whether to switch the current playback time of the target multimedia data, and has a far more reference value than the traditional thumbnail images of the target multimedia data.

For example, in the situation illustrated in FIG. 6, the value represented by the indicator object 518 on the statistical graph 500 is the largest among the others, which provides the user with very important reference information. Namely, it represents that the content of the target multimedia data in the period corresponding to the indicator object 518 is highly likely to be more interesting, receives more attention, causes more discussion, or has higher rating. Accordingly, the user may simply instruct the first multimedia playback device 130 to directly switch the target multimedia data being currently played to a time point corresponding to the indicator object 518.

In one embodiment, the user may control the cursor 620 through the input device 134 to move the cursor 620 to the progress indicator 632 on the progress bar 630, and then to drag the progress indicator 632 to a position corresponding to the indicator object 518. As a result, the first control circuit 135 controls at least one of the first display device 132 and the first speaker 133 to switch the target multimedia data being currently played to a portion corresponding to the period corresponding to the indicator object 518.

In another embodiment, the user may control the cursor 620 through the input device 134 to move the cursor 620 to the indicator object 518 and then to click the indicator object 518, so as to switch the playback time point of the target multimedia data. When the indicator object 518 is selected by the user through the input device 134, the first control circuit 135 controls at least one of the first display device 132 and the first speaker 133 to switch the target multimedia data being currently played to a portion corresponding to the period corresponding to the indicator object 518.

As previously described, when the target multimedia data being currently played by the first multimedia playback device 130 is switched to a portion corresponding to the period corresponding to the indicator object 518, the second control circuit 145 also controls at least one of the second display device 142 and the second speaker 143 to synchronously play one or more auxiliary multimedia data corresponding to the period corresponding to the indicator object 518.

Since the time indicator 660 has the functionality similar to the progress indicator 632, the statistical graph 500 and the time indicator 660 can be employed to replace the progress bar 630 and the progress indicator 632.

While the first multimedia playback device 130 plays the target multimedia data, when the user issues a command through the input device 134 to request for adjusting a display area of the target multimedia data, e.g., to request for adjusting the size of the display region 610 or the partial region 612, the playback module 230 of the computer program product 137 controls the first display device 132 to correspondingly adjust the display area of the target multimedia data, and the statistical graph generating module 220 correspondingly adjusts the predetermined length of time corresponding to each indicator object on the aforementioned statistical graph 500.

Specifically, when the playback module 230 controls the first display device 132 to reduce the display area of target multimedia data, the statistical graph generating module 220 increases the aforementioned predetermined length of time to reduce the quantity of the indicator object on the statistical graph 500, so as to increase the width of each indicator object for facilitating the user to identify respective indicator objects.

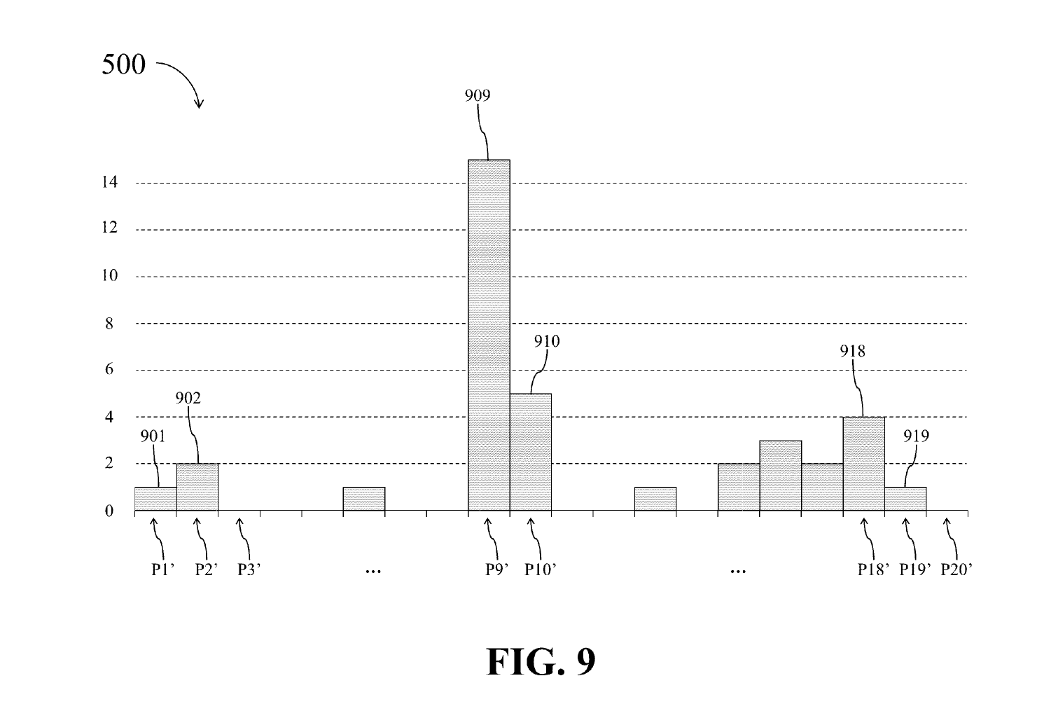

For example, FIG. 9 shows a simplified enlarged schematic diagram of the statistical graph 500 according to another embodiment of the present disclosure. The statistical graph 500 in FIG. 9 is similarly presented in the format of the histogram, and the numbers located at the left side of the statistical graph 500 are utilized for expressing a quantity distribution of specific items with respect to each period. The statistical graph 500 in FIG. 9 is very similar to the statistical graph 500 in FIG. 5, and the difference only lies in the predetermined length of time corresponding to each indicator object. In the statistical graph 500 of FIG. 9, the predetermined length of time corresponding to each indicator object is twice of that in the statistical graph 500 of FIG. 5. Accordingly, in FIG. 9, the length of the period P1′ is equal to the total length of the periods P1 and P2 in FIG. 5, the length of the period P2′ is equal to the total length of the periods P3 and P4 in FIG. 5, the length of the period P3′ is equal to the total length of the periods P5 and P6 in FIG. 5, the length of the period P9′ is equal to the total length of the periods P17 and P18 in FIG. 5, the length of the period P10′ is equal to the total length of the periods P19 and P20 in FIG. 5, the length of the period P19′ is equal to the total length of the periods P37 and P38 in FIG. 5, and so forth.

In the embodiment where the aforementioned data distribution information is utilized for describing the distribution of the multiple auxiliary multimedia data on the time axis, the first control circuit 135 converts the distribution of the multiple auxiliary multimedia data in the periods P1˜P40 into multiple indicator objects on the statistical graph 500 in FIG. 9, so that the multiple indicator objects respectively correspond to the periods P1′˜P20′. In this situation, each of the multiple indicator objects represents a total quantity of auxiliary multimedia data corresponding to one of the periods P1′˜P20′. Accordingly, the statistical graph 500 generated by the first control circuit 135 may be utilized for expressing the distribution of the multiple auxiliary multimedia data on the time axis. For example, in this case an indicator object 901 on the statistical graph 500 represents the total quantity of auxiliary multimedia data appearing in the period P1′, an indicator object 902 represents the total quantity of auxiliary multimedia data appearing in the period P2′, an indicator object 903 represents the total quantity of auxiliary multimedia data appearing in the period P3′, an indicator object 909 represents the total quantity of auxiliary multimedia data appearing in the period P9′, an indicator object 910 represents the total quantity of auxiliary multimedia data appearing in the period P10′, an indicator object 919 represents the total quantity of auxiliary multimedia data appearing in the period P19′, and so forth.

In the embodiment where the aforementioned data distribution information is utilized for describing the distribution of the multiple statistical data on the time axis, the first control circuit 135 converts the distribution of the multiple statistical data in the periods P1˜P40 into the multiple indicator objects on the statistical graph 500 in FIG. 9, so that the multiple indicator objects respectively correspond to the periods P1′˜P20′. In this situation, each of the multiple indicator objects represents a sum or weighted-blending result of statistical data corresponding to one of the periods P1′˜P20′. Accordingly, the statistical graph 500 generated by the first control circuit 135 may be utilized for expressing the distribution of the multiple statistical data on the time axis. For example, in this case the indicator object 901 on the statistical graph 500 represents the sum or weighted-blending result of statistical data corresponding to the period P1′, the indicator object 902 represents the sum or weighted-blending result of statistical data corresponding to the period P2′, the indicator object 903 represents the sum or weighted-blending result of statistical data corresponding to the period P3′, the indicator object 909 represents the sum or weighted-blending result of statistical data corresponding to the period P9′, the indicator object 910 represents the sum or weighted-blending result of statistical data corresponding to the period P10′, the indicator object 919 represents the sum or weighted-blending result of statistical data corresponding to the period P19′, and so forth.

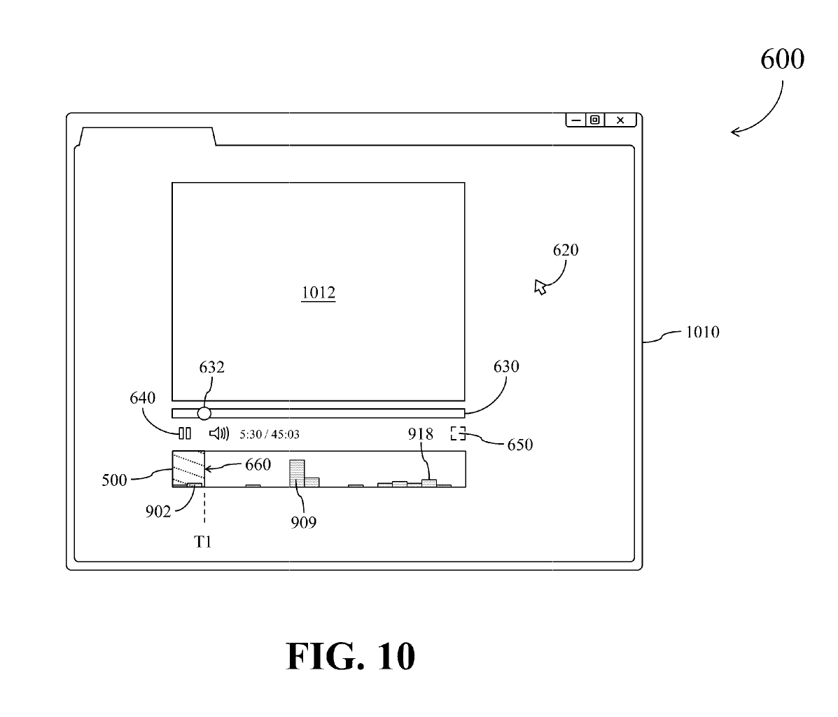

Please refer to FIG. 10, which shows a simplified schematic diagram of playing the target multimedia data conducted by the first multimedia playback device 130 according to another embodiment of the present disclosure. In the embodiment of FIG. 10, the first control circuit 135 controls the first display device 132 to reduce the display region 610 within the aforementioned image 600 to be a display region 1010. Accordingly, the partial region 612 originally utilized for displaying the target multimedia data is also reduced to be a partial region 1012. Although the length of the statistical graph 500 in FIG. 10 is reduced proportionally, the reference value of the indicator objects on the statistical graph 500 would not be adversely affected since the statistical graph generating module 220 increases the aforementioned predetermined length of time to thereby increase the width of each indicator object, so that the user is enabled to clearly identify the indicator objects.

Similarly, when the playback module 230 controls the first display device 132 to increase the display area of the target multimedia data, the statistical graph generating module 220 may reduce the aforementioned predetermined length of time to increase the quantity of indicator objects on the statistical graph 500, so as to increase the resolution of respective indicator objects on the statistical graph 500 for facilitating the user to distinguish different indicator objects.

While the first multimedia playback device 130 plays the target multimedia data, the user may move the cursor 620 within the image 600 to the full-screen-mode key 650 and click the full-screen-mode key 650 to issue a full screen displaying command. In this case, the playback module 230 utilizes the first display device 132 to display the target multimedia data in a full screen mode.

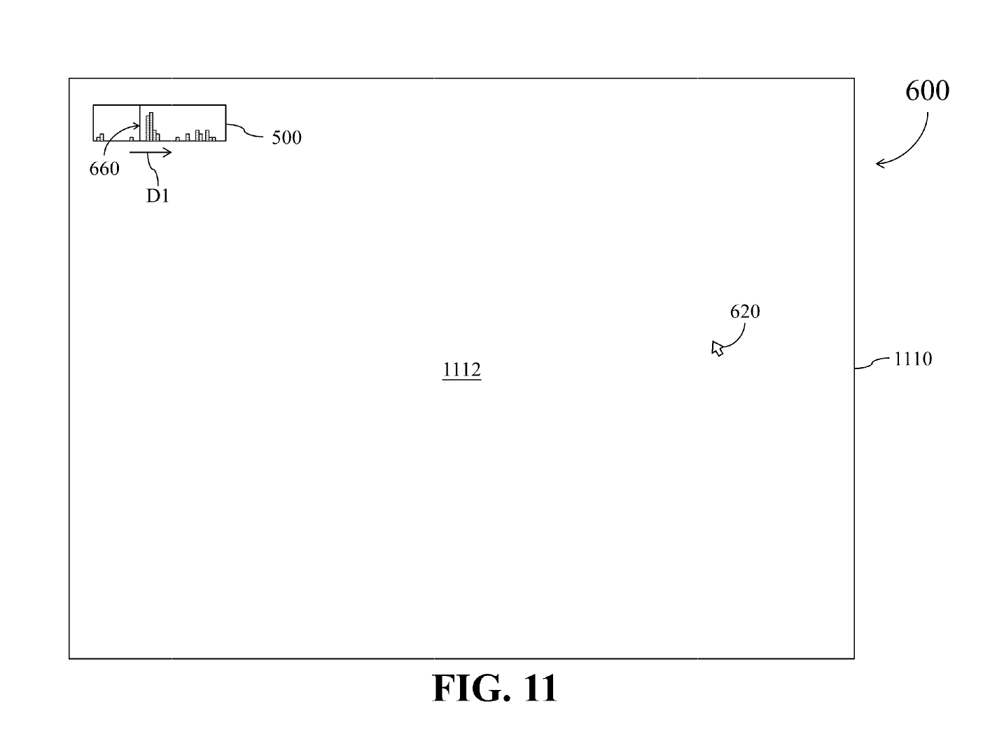

Please refer to FIG. 11, which shows a simplified schematic diagram of playing the target multimedia data in a full screen mode conducted by the first multimedia playback device 130 according to one embodiment of the present disclosure. In the embodiment of FIG. 11, the playback module 230 utilizes the first control circuit 135 to control the first display device 132 to enlarge the display region 610 within the image 600 to be a display region 1110 fully occupying the entire display range of the first display device 132. Accordingly, the partial region 612 originally utilized for displaying the target multimedia data is also enlarged to be a partial region 1112.

In the full screen mode, the progress bar 630 and the progress indicator 632 are no longer appearing in the partial region 1112. For providing the reference data for the user in deciding whether to switch the current playback time of the target multimedia data, when the playback module 230 utilizes the first display device 132 to display the target multimedia data in the full screen mode, the playback module 230 utilizes the first control circuit 135 to control the first display device 132 to keep displaying at least a portion of the aforementioned statistical graph 500.

As shown in FIG. 11, the playback module 230 controls the first display device 132 to keep displaying all or part of the aforementioned statistical graph 500 in the top layer of the image 600, so that the user may continue to regard the statistical graph 500 as reference data in deciding whether to switch the playback time of the target multimedia data.

The same as the aforementioned embodiment, the playback module 230 further utilizes the first display device 132 to synchronously move the position of the time indicator 660 during the playback of the target multimedia data, so that the time indicator 660 on the statistical graph 500 has a functionality for indicating the playback progress similar to the functionality of the progress indicator 632. In the embodiment of FIG. 11, the playback module 230 utilizes the first display device 132 to synchronously move the position of the time indicator 660 toward a direction D1 during the playback of the target multimedia data.

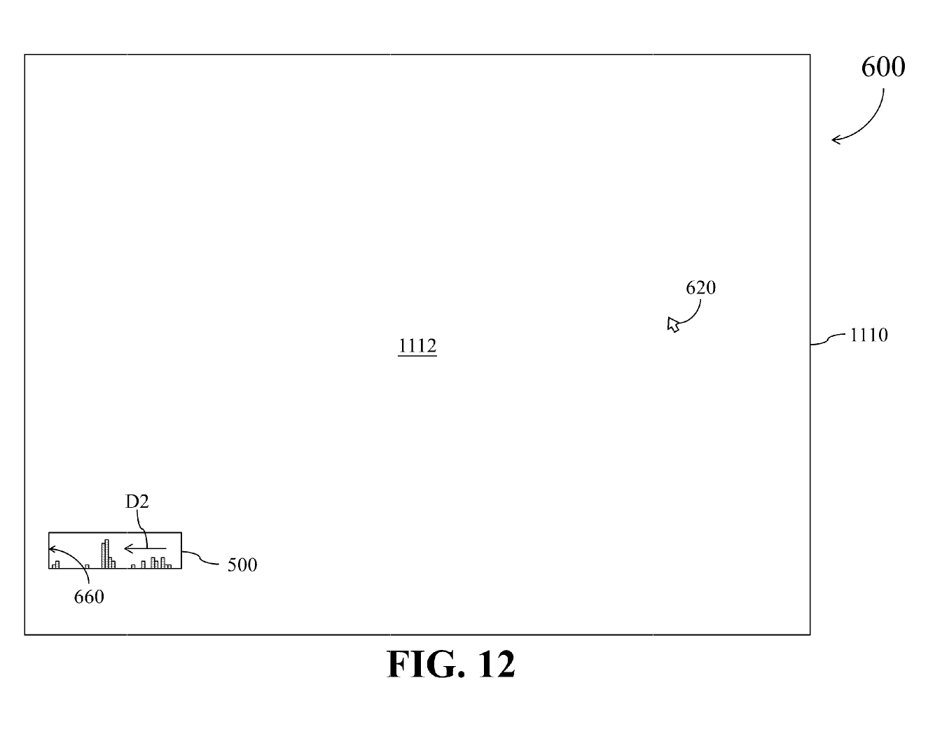

Please refer to FIG. 12, which shows a simplified schematic diagram of playing the target multimedia data in a full screen mode conducted by the first multimedia playback device 130 according to another embodiment of the present disclosure. In the embodiment of FIG. 12, the playback module 230 also utilizes the first display device 132 to display the target multimedia data in a full screen mode.

As shown in FIG. 12, the playback module 230 controls the first display device 132 to keep displaying all or part of the aforementioned statistical graph 500 in the top layer of the image 600, and utilizes the left boundary of the statistical graph 500 as the time indicator 660.

One of the differences between the embodiments of FIG. 12 and FIG. 11 is the position of the statistical graph 500. The playback module 230 may adjust the position of the statistical graph 500 within the image 600 according to default rules or configuration made by the user.

Another difference between the embodiments of FIG. 12 and FIG. 11 is that the playback module 230 in the embodiment of FIG. 12 does not move the position of the time indicator 660 during the playback of the target multimedia data. Instead, the playback module 230 in the embodiment of FIG. 12 utilizes the first display device 132 to synchronously move the multiple indicator objects on the statistical graph 500 toward a direction D2 opposite to the direction D1, i.e., to synchronously move the multiple indicator objects toward the time indicator 660, during the playback of the target multimedia data. As a result, even the position of the time indicator 660 remains unchanged during the playback of the target multimedia data, the time indicator 660 still has functionality for indicating the playback progress similar to the functionality of the progress indicator 632.

In the embodiment of FIG. 12, the time indicator 660 may be instead realized with a fixed vertical line positioned in other place within the statistical graph 500.

Please note that the aforementioned executing order of the operations of FIG. 3 is merely an exemplary embodiment rather than a restriction to the practical implementations of the invention. For example, the operation 318 may be adjusted to be before the operation 308 or 312, or may be performed simultaneously with the operation 306 or 308. In addition, the operation 320 may be adjusted to be before the operation 312, or may be performed simultaneously with the operation 310 or 312.

In the aforementioned embodiments, the computer program product 137 stored in the memory 136 of the first multimedia playback device 130 may be an application program or a plug-in downloaded from other servers by the first multimedia playback device 130 in advance through the network 150 and pre-installed in the first multimedia playback device 130.

Alternatively, the computer program product 137 may be provided for the first multimedia playback device 130 by the target data provider device 110 or the auxiliary data provider device 120. In one embodiment, the target data provider device 110 may transmit the computer program product 137 to the first multimedia playback device 130 through web pages or other ways when the first multimedia playback device 130 requests to provide a target multimedia data. For example, the target data provider device 110 may transmit the computer program product 137 to the first multimedia playback device 130 in the aforementioned operation 310.

In another embodiment, the auxiliary data provider device 120 may transmit the computer program product 137 to the first multimedia playback device 130 through web pages or other ways when transmitting the data distribution information corresponding to the target multimedia data to the first multimedia playback device 130. For example, the auxiliary data provider device 120 may transmit the computer program product 137 to the first multimedia playback device 130 in the aforementioned operation 320.

As can be appreciated from the foregoing descriptions, since the first multimedia playback device 130 displays the statistical graph 500 related to the auxiliary multimedia data in the second multimedia playback device 140 for the user to reference, the user is thus enabled to decide whether to switch the current playback time of the target multimedia data being currently played by the first multimedia playback device 130 according to the statistical graph 500, and to synchronously switch the playback timing of the auxiliary multimedia data played by the second multimedia playback device 140, thereby greatly increasing the selection flexibility for the user in deciding whether to switch the playback time point of the target multimedia data.

In addition, the integrity and correlation between the target multimedia data played by the first multimedia playback device 130 and the auxiliary multimedia data played by the second multimedia playback device 140 could be effectively increased by displaying the aforementioned the statistical graph 500 and the time indicator 660 with the first multimedia playback device 130. For example, through the statistical graph 500 and the time indicator 660 displayed by the first multimedia playback device 130, the user is enabled to obtain the playback timing and the related information of the multiple auxiliary multimedia data played by the second multimedia playback device 140, and thus would not miss the auxiliary multimedia data played by the second multimedia playback device 140.

As a result, the aforementioned multimedia delivery system 100 enables the user to immediately and accurately obtain needed information without interrupting the playback of the target multimedia data. Additionally, the architecture of the multimedia delivery system 100 not only allows the supplier of the auxiliary multimedia data to more accurately deliver the auxiliary multimedia data to the user of interest, but also enables the user to dynamically switch the observation between the target multimedia data played by the first multimedia playback device 130 and the auxiliary multimedia data played by the second multimedia playback device 140 according to the personal requirement.

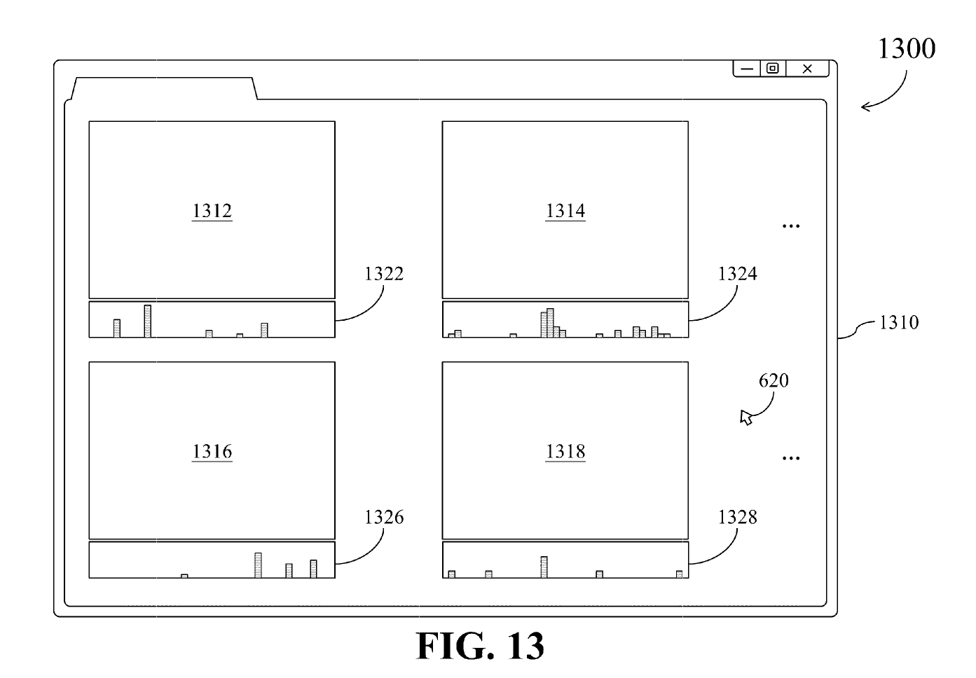

In practice, the first multimedia playback device 130 may simultaneously display multiple different target multimedia data and multiple corresponding statistical graphs in the same image, and utilizes the multiple statistical graphs as important reference data for the user in selecting which target multimedia data to be played. For example, FIG. 13 shows a simplified schematic diagram of playing the target multimedia data conducted by the first multimedia playback device 130 of FIG. 1 according to another embodiment of the present disclosure. In the embodiment of FIG. 13, the playback module 230 utilizes the first control circuit 135 to control the first display device 132 to display a selection image 1300. The selection image 1300 comprises a display region 1310 and the cursor 620. The display region 1310 may be a window region of an application program (such as a web browser or a multimedia player). In this embodiment, the playback module 230 utilizes the first display device 132 to respectively display representative images (such as representative images 1312, 1314, 1316, and 1318 shown in FIG. 13) of multiple target multimedia data in the display region 1310.

In addition, the playback module 230 further utilizes the first display device 132 to display a statistical graph corresponding to each target multimedia data aside the representative image of the target multimedia data to be a selection indicator for the target multimedia data. In the embodiment of FIG. 13, the playback module 230 utilizes the first display device 132 to display a first statistical graph 1322 corresponding to a first target multimedia data aside the representative image 1312 of the first target multimedia data, to display a second statistical graph 1324 corresponding to a second target multimedia data aside the representative image 1314 of the second target multimedia data, to display a third statistical graph 1326 corresponding to a third target multimedia data aside the representative image 1316 of the third target multimedia data, and to display a fourth statistical graph 1328 corresponding to a fourth target multimedia data aside the representative image 1318 of the fourth target multimedia data.

Similar to aforementioned embodiments, the target data provider device 110 may store the first to the fourth target multimedia data in the first storage device 112, and transmit the first to the fourth target multimedia data to the first multimedia playback device 130 when received the data request from the first multimedia playback device 130.

The auxiliary data provider device 120 stores multiple first auxiliary multimedia data related to the first target multimedia data, multiple second auxiliary multimedia data related to the second target multimedia data, multiple third auxiliary multimedia data related to the third target multimedia data, and multiple fourth auxiliary multimedia data related to the fourth target multimedia data. The auxiliary data provider device 120 further generates a first data distribution information, a second data distribution information, a third data distribution information, and a fourth data distribution information. The first data distribution information is related to the distribution of the multiple first auxiliary multimedia data on a time axis, or related to the distribution of multiple first statistical data of the multiple first auxiliary multimedia data on the time axis. The second data distribution information is related to the distribution of the multiple second auxiliary multimedia data on a time axis, or related to the distribution of multiple second statistical data of the multiple second auxiliary multimedia data on the time axis. The third data distribution information is related to the distribution of the multiple third auxiliary multimedia data on a time axis, or related to the distribution of multiple third statistical data of the multiple third auxiliary multimedia data on the time axis. The fourth data distribution information is related to the distribution of the multiple fourth auxiliary multimedia data on a time axis, or related to the distribution of multiple fourth statistical data of the multiple fourth auxiliary multimedia data on the time axis.

When the first multimedia playback device 130 transmits the data request to the target data provider device 110, the first multimedia playback device 130 receives the first to the fourth target multimedia data transmitted from the target data provider device 110, and receives the first to the fourth data distribution information transmitted from the auxiliary data provider device 120. Similarly, the second multimedia playback device 140 receives the multiple first auxiliary multimedia data, the multiple second auxiliary multimedia data, the multiple third auxiliary multimedia data, and the multiple fourth auxiliary multimedia data transmitted from the auxiliary data provider device 120.

As described previously, the first multimedia playback device 130 respectively generates the aforementioned statistical graphs 1322, 1324, 1326, and 1328 according to the first to the fourth data distribution information. The first statistical graph 1322 is utilized for expressing the distribution of the multiple first auxiliary multimedia data on the time axis, or for expressing the distribution of the multiple first statistical data on the time axis. The second statistical graph 1324 is utilized for expressing the distribution of the multiple second auxiliary multimedia data on the time axis, or for expressing the distribution of the multiple second statistical data on the time axis. The third statistical graph 1326 is utilized for expressing the distribution of the multiple third auxiliary multimedia data on the time axis, or for expressing the distribution of the multiple third statistical data on the time axis. The fourth statistical graph 1328 is utilized for expressing the distribution of the multiple fourth auxiliary multimedia data on the time axis, or for expressing the distribution of the multiple fourth statistical data on the time axis.

When the user instructs the first multimedia playback device 130 to display the selection image 1300, the first multimedia playback device 130 simultaneously displays the representative images 1312, 1314, 1316, and 1318 and the statistical graphs 1322, 1324, 1326, and 1328 corresponding to the first to the fourth target multimedia data. As a result, the user is enabled to select which target multimedia data to be played according to the statistical graphs 1322, 1324, 1326, and 1328 displayed in the selection image 1300. In other words, the aforementioned statistical graphs 1322, 1324, 1326, and 1328 generated by the first multimedia playback device 130 could be employed as reference basis for the user in selecting a target multimedia data to be played, thereby increasing the accuracy in selecting the target multimedia data.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled with,” “couples with,” and “coupling with” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A multimedia delivery system, comprising:
a target data provider device, configured to operably store and transmit a target multimedia data;
an auxiliary data provider device, configured to operably store and transmit multiple auxiliary multimedia data related to the target multimedia data, and to operably generate and transmit a data distribution information, wherein the data distribution information is related to a distribution of the multiple auxiliary multimedia data on a time axis, or a distribution of multiple statistical data respectively corresponding to the multiple auxiliary multimedia data on the time axis;
a first multimedia playback device, configured to operably receive the target multimedia data transmitted from the target data provider device, to operably receive the data distribution information transmitted from the auxiliary data provider device, to operably generate a statistical graph according to the data distribution information, to operably play the target multimedia data, and to synchronously display at least a portion of the statistical graph during playback of the target multimedia data; and
a second multimedia playback device, configured to operably receive the multiple auxiliary multimedia data transmitted from the auxiliary data provider device, and to synchronously display at least one of the multiple auxiliary multimedia data while the first multimedia playback device plays the target multimedia data;
wherein the statistical graph is utilized for expressing the distribution of the multiple auxiliary multimedia data on the time axis, or for expressing the distribution of the multiple statistical data on the time axis.

2. The multimedia delivery system of claim 1, wherein the target data provider device comprises:
a first storage device, configured to operably store the target multimedia data;
a first transmission circuit; and
a first processing circuit, coupled with the first storage device and the first transmission circuit, configured to operably control the first transmission circuit to transmit the target multimedia data;
wherein the auxiliary data provider device comprises:
a second storage device, configured to operably store the multiple auxiliary multimedia data and the data distribution information;
a second transmission circuit; and
a second processing circuit, coupled with the second storage device and the second transmission circuit, configured to operably generate the data distribution information, and to operably control the second transmission circuit to transmit the multiple auxiliary multimedia data and the data distribution information;
wherein the first multimedia playback device comprises:
a first communication circuit, configured to operably receive the target multimedia data transmitted from the target data provider device, and to operably receive the data distribution information transmitted from the auxiliary data provider device;
a first display device;
a first speaker; and
a first control circuit, coupled with the first communication circuit, the first display device, and the first speaker, configured to operably generate the statistical graph according to the data distribution information, to operably control at least one of the first display device and the first speaker to play the target multimedia data, and to operably control the first display device to synchronously display at least a portion of the statistical graph during the playback of the target multimedia data;
wherein the second multimedia playback device comprises:
a second communication circuit, configured to operably receive the multiple auxiliary multimedia data transmitted from the auxiliary data provider device;
a second display device;
a second speaker; and
a second control circuit, coupled with the second communication circuit, the second display device, and the second speaker, configured to operably control at least one of the second display device and the second speaker to synchronously play at least one of the multiple auxiliary multimedia data while the first multimedia playback device plays the target multimedia data.

3. The multimedia delivery system of claim 2, wherein the second processing circuit further controls the second transmission circuit to transmit multiple playback timing information respectively corresponding to the multiple auxiliary multimedia data to the second communication circuit, and the second control circuit controls playback timing of the multiple auxiliary multimedia data according to the multiple playback timing information.

4. The multimedia delivery system of claim 2, wherein the first control circuit further provides playback timing information of the target multimedia data for the second control circuit through the first communication circuit, and the second control circuit controls playback timing of the multiple auxiliary multimedia data according to the playback timing information.

5. The multimedia delivery system of claim 2, wherein the first multimedia playback device further comprises:
an input device, coupled with the first control circuit;
wherein when a pause command is received by the input device, the first control circuit transmits a pause notice to the second transmission circuit through the first communication circuit, and when the pause notice is received by the second transmission circuit, the second processing circuit instructs the second multimedia playback device to pause playing the multiple auxiliary multimedia data through the second transmission circuit.

6. The multimedia delivery system of claim 2, wherein the first multimedia playback device further comprises:
an input device, coupled with the first control circuit;
wherein when a pause command is received by the input device, the first control circuit further utilizes the first communication circuit to provide a pause notice for the second control circuit through the second communication circuit, so that the second control circuit controls the second display device and the second speaker to pause playing the multiple auxiliary multimedia data.

7. The multimedia delivery system of claim 2, wherein the statistical graph is a histogram or a line chart.

8. The multimedia delivery system of claim 7, wherein the first control circuit converts the distribution of the multiple auxiliary multimedia data or the multiple statistical data with respect to multiple different periods into multiple indicator objects on the statistical graph, so that the multiple indicator objects respectively correspond to the multiple different periods, and each of the multiple different periods has a predetermined length of time the same as each other.

9. The multimedia delivery system of claim 8, wherein each indicator object of the multiple indicator objects represents a sum or weighted-blending result of statistical data corresponding to one of the multiple different periods.

10. The multimedia delivery system of claim 9, wherein the multiple statistical data are multiple ranking scores or multiple annotation counts respectively corresponding to the multiple auxiliary multimedia data.

11. The multimedia delivery system of claim 8, wherein each indicator object of the multiple indicator objects represents a total quantity of auxiliary multimedia data corresponding to one of the multiple different periods.

12. The multimedia delivery system of claim 8, wherein a target indicator object of the multiple indicator objects corresponds to a target period of the multiple different periods, and the first multimedia playback device further comprises:
an input device, coupled with the first control circuit;
wherein when the target indicator object is selected by a user through the input device, the first control circuit controls at least one of the first display device and the first speaker to switch the target multimedia data being currently played to a portion corresponding to the target period.

13. The multimedia delivery system of claim 8, wherein when the first control circuit controls the first display device to reduce a display area of the target multimedia data, the first control circuit increases the predetermined length of time, and when the first control circuit controls the first display device to increase the display area of the target multimedia data, the first control circuit reduces the predetermined length of time.

14. The multimedia delivery system of claim 8, wherein the first control circuit further controls the first display device to display a time indicator corresponding to a current playback time of the target multimedia data on the statistical graph.

15. The multimedia delivery system of claim 14, wherein the first control circuit further controls the first display device to move a position of the time indicator or positions of the multiple indicator objects with time during the playback of the target multimedia data.

16. The multimedia delivery system of claim 15, wherein when the first control circuit utilizes the first display device to display the target multimedia data in a full screen mode, the first control circuit controls the first display device to keep displaying at least a portion of the statistical graph.

17. A multimedia delivery system, comprising:
a target data provider device, configured to operably store and transmit a first target multimedia data and a second target multimedia data;
an auxiliary data provider device, configured to operably store and transmit multiple first auxiliary multimedia data related to the first target multimedia data, to operably store and transmit multiple second auxiliary multimedia data related to the second target multimedia data, to operably generate and transmit a first data distribution information, and to operably generate and transmit a second data distribution information, wherein the first data distribution information is related to a distribution of the multiple first auxiliary multimedia data on a time axis or related to a distribution of multiple first statistical data respectively corresponding to the multiple first auxiliary multimedia data on the time axis, and the second data distribution information is related to a distribution of the multiple second auxiliary multimedia data on the time axis or related to a distribution of multiple second statistical data respectively corresponding to the multiple second auxiliary multimedia data on the time axis;
a first multimedia playback device, configured to operably receive the first target multimedia data and the second target multimedia data transmitted from the target data provider device, to operably receive the first data distribution information and the second data distribution information transmitted from the auxiliary data provider device, to operably generate a first statistical graph according to the first data distribution information, to operably generate a second statistical graph according to the second data distribution information, and to synchronously display a first representative image of the first target multimedia data, a second representative image of the second target multimedia data, at least a portion of the first statistical graph, and at least a portion of the second statistical graph; and
a second multimedia playback device, configured to operably receive the multiple first auxiliary multimedia data and the multiple second auxiliary multimedia data transmitted from the auxiliary data provider device;
wherein the first statistical graph is utilized for expressing the distribution of the multiple first auxiliary multimedia data on the time axis or for expressing the distribution of the multiple first statistical data on the time axis, and the second statistical graph is utilized for expressing the distribution of the multiple second auxiliary multimedia data on the time axis or for expressing the distribution of the multiple second statistical data on the time axis;
wherein after the first representative image is selected by a user, the first multimedia playback device starts to play the first target multimedia data, and synchronously displays at least a portion of the first statistical graph during playback of the first target multimedia data, and the second multimedia playback device synchronously plays at least one of the multiple first auxiliary multimedia data while the first multimedia playback device plays the first target multimedia data.

18. A computer program product, stored in a non-transitory storage device of a first multimedia playback device in a multimedia delivery system, when executed by a control circuit of the first multimedia playback device, enabling the first multimedia playback device to perform a multimedia playback operation, wherein the multimedia delivery system comprises a target data provider device, an auxiliary data provider device, the first multimedia playback device, and a second multimedia playback device, and the first multimedia playback device comprises a communication circuit, a display device, a speaker, and the control circuit, the computer program product comprising:
a receiving module, for utilizing the communication circuit to receive a target multimedia data transmitted from the target data provider device, and to receive a data distribution information transmitted from the auxiliary data provider device, wherein the data distribution information is related to a distribution of multiple auxiliary multimedia data related to the target multimedia data on a time axis or related to a distribution of multiple statistical data respectively corresponding to the multiple auxiliary multimedia data on the time axis;
a statistical graph generating module, for utilizing the control circuit to generate a statistical graph according to the data distribution information, wherein the statistical graph is utilized for expressing the distribution of the multiple auxiliary multimedia data on the time axis or for expressing the distribution of the multiple statistical data on the time axis; and
a playback module, for utilizing at least one of the display device and the speaker to play the target multimedia data, and for utilizing the display device to synchronously display at least a portion of the statistical graph during playback of the target multimedia data.

19. The computer program product of claim 18, wherein the auxiliary data provider device transmits the multiple auxiliary multimedia data to the second multimedia playback device, and the computer program product further comprises:
a timing notifying module, for utilizing the communication circuit to provide a playback timing information of the target multimedia data for the second multimedia playback device, so that the second multimedia playback device controls playback timing of the multiple auxiliary multimedia data according to the playback timing information.

20. The computer program product of claim 18, wherein the first multimedia playback device further comprises an input device coupled with the control circuit, and the computer program product further comprises:
a timing notifying module;
wherein when a pause command is received by the receiving module through the input device, the timing notifying module utilizes the communication circuit to transmit a pause notice to the auxiliary data provider device, so that the auxiliary data provider device instructs the second multimedia playback device to pause playing the multiple auxiliary multimedia data.

21. The computer program product of claim 18, wherein the first multimedia playback device further comprises an input device coupled with the control circuit, and the computer program product further comprises:
a timing notifying module;
wherein when a pause command is received by the receiving module through the input device, the timing notifying module utilizes the communication circuit to provide a pause notice for the second multimedia playback device, so as to control the second multimedia playback device to pause playing the multiple auxiliary multimedia data.

22. The computer program product of claim 18, wherein the statistical graph is a histogram or a line chart.

23. The computer program product of claim 22, wherein the statistical graph generating module converts a distribution of the multiple auxiliary multimedia data or the multiple statistical data with respect to multiple different periods into multiple indicator objects on the statistical graph, so that the multiple indicator objects respectively correspond to the multiple different periods, and each of the multiple different periods has a predetermined length of time the same as each other.

24. The computer program product of claim 23, wherein each indicator object of the multiple indicator objects represents a sum or weighted-blending result of statistical data corresponding to one of the multiple different periods.

25. The computer program product of claim 24, wherein the multiple statistical data are multiple ranking scores or multiple annotation counts respectively corresponding to the multiple auxiliary multimedia data.

26. The computer program product of claim 23, wherein each indicator object of the multiple indicator objects represents a total quantity of auxiliary multimedia data corresponding to one of the multiple different periods.

27. The computer program product of claim 23, wherein a target indicator object of the multiple indicator objects corresponds to a target period of the multiple different periods, and the first multimedia playback device further comprises an input device coupled with the control circuit;
wherein when the target indicator object is selected by a user through the input device, the playback module controls at least one of the display device and the speaker to switch the target multimedia data being currently played to a portion corresponding to the target period.

28. The computer program product of claim 23, wherein when the playback module controls the display device to reduce a display area of the target multimedia data, the statistical graph generating module increases the predetermined length of time, and when the playback module controls the display device to increase the display area of the target multimedia data, the statistical graph generating module reduces the predetermined length of time.

29. The computer program product of claim 23, wherein the playback module further utilizes the display device to display a time indicator corresponding to a current playback time of the target multimedia data on the statistical graph.

30. The computer program product of claim 29, wherein the playback module further utilizes the display device to move a position of the time indicator or positions of the multiple indicator objects with time during the playback of the target multimedia data.

31. The computer program product of claim 30, wherein when the playback module utilizes the display device to display the target multimedia data in a full screen mode, the playback module controls the display device to keep displaying at least a portion of the statistical graph.
